(19) United States
(12) Patent Application Publication
(10) Pub. No.: US 2023/0196749 A1
(43) Pub. Date: Jun. 22, 2023

(54) Training Neural Networks for Object Detection

(71) Applicant: GM Cruise Holdings LLC, San Francisco, CA (US)

(72) Inventors: Siddharth Mahendran, Mountain View, CA (US); Yong Jae Lee, Walnut Creek, CA (US); Teng Liu Liu, Jersey City, NJ (US); Marzieh Parandehgheibi, San Francisco, CA (US); Bo Tian, Milpitas, CA (US); Aleksandr Sidorov, Mountain View, CA (US)

(21) Appl. No.: 17/554,894

(22) Filed: Dec. 17, 2021

(51) Int. Cl. G06V 10/82; G06N 3/08; G06T 7/521; G01S 17/894

(52) U.S. Cl. CPC G06V 10/82; G06N 3/08; G06T 7/521; G01S 17/894

(57) ABSTRACT

Disclosed are systems, apparatuses, methods, and computer-readable media to train a neural network model implemented into a perception stack in an autonomous vehicle (AV) for detecting objects. A method includes receiving a 3D light and detection ranging (LIDAR) data to train a neural network model having residual connections for detecting objects in LIDAR data; converting each frame of the LIDAR data into a voxelized frame to yield a training dataset of voxelized frames; and training the neural network model based on the training dataset of voxelized frames and a feedback control to control input from the training dataset of voxelized frames into the neural network model.

### TECHNICAL FIELD

The subject technology is related to autonomous driving vehicles and, in particular, for training a neural network to be used in autonomous driving vehicles for detecting objects.

### BACKGROUND

Autonomous vehicles are vehicles having computers and control systems that perform driving and navigation tasks that are conventionally performed by a human driver. As autonomous vehicle technologies continue to advance, ride-sharing services will increasingly utilize autonomous vehicles to improve service efficiency and safety. However, autonomous vehicles will be required to perform many of the functions that are conventionally performed by human drivers, such as avoiding dangerous or difficult routes, and performing other navigation and routing tasks necessary to provide safe and efficient transportation. Such tasks may require the collection and processing of large quantities of data disposed on the autonomous vehicle.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example of an autonomous vehicle (AV) management system according to an example of the instant disclosure;

FIG. 2 illustrates an example diagram of a Continuous Learning Machine (CLM) for resolving uncommon scenarios in an AV according to an example of the instant disclosure;

FIG. 3 illustrates an example of a configuration of the neural network according to an example of the instant disclosure;

FIG. 4 illustrates an example use of a neural network for detecting features in an image according to an example of the instant disclosure;

FIG. 5 illustrates an example of a residual learning building block that can reduce backpropagation to stack additional layers according to an example of the instant disclosure;

FIG. 6 illustrates an example illustration of training a residual neural network (ResNet) training system according to an example of the instant disclosure;

FIG. 7 illustrates an example method for training the neural network model based on a training dataset of frames according to an example of the instant disclosure; and

FIG. 8 illustrates an example of a computing system according to an example of the instant disclosure.

### DETAILED DESCRIPTION

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Overview

Systems, methods, and computer-readable media are disclosed for training a neural network that is used to detect objects in an environment associated with an autonomous vehicle. In some examples, a distributed training system is configured to train a neural network having residual connections based on sensor data such as, for example, a light and detection ranging (LIDAR) dataset. The training method comprises receiving a 3D LIDAR data to train a neural network model having residual connections for detecting objects in LIDAR data, converting each frame of the LIDAR data into a voxelized frame to yield a training dataset of voxelized frames, and training the neural network model based on the training dataset of voxelized frames and a feedback control to control input from the training dataset of voxelized frames into the neural network model.

In one example, the neural network model comprises a 23-layer residual neural network (ResNet) model and the residual connection skips at least one layer of the 23 layer ResNet model. The ResNet model is trained by a distributed system across a large number of nodes due to the mathematical complexity. Each node of the distributed system executes the training module, which includes a max pool layer to dynamically resize the voxelized frame as confidence in the ResNet model increases. Conventional model training resizes input datasets prior to training and creates different batches of datasets. By dynamically resizing the voxelized frame, the disclosed method conserves time by only resizing content as needed rather than resizing an entire dataset.

In another example, the ResNet model reduces training time by using the residual connection, which alleviates backward propagation of weights into earlier layers of the neural network model. ResNet also allows increased complexity by increasing the number of layers because reducing backward propagation allows stacking of more layers. As disclosed below, a ResNet model with more layers than a visual geometry group (VGG) model can improve model training speed without sacrificing accuracy. In another example, the ResNet model can also omit the usage of synchronized batch normalization to reduce network traffic and use a standard batch normalization within a node to address internal covariate shift and improve initial model performance. These and other improvements yield an improvement in the training time of a model to improve iteration time and deployment of machine learning (ML) models and improve autonomous vehicle performance.

### Example Embodiments

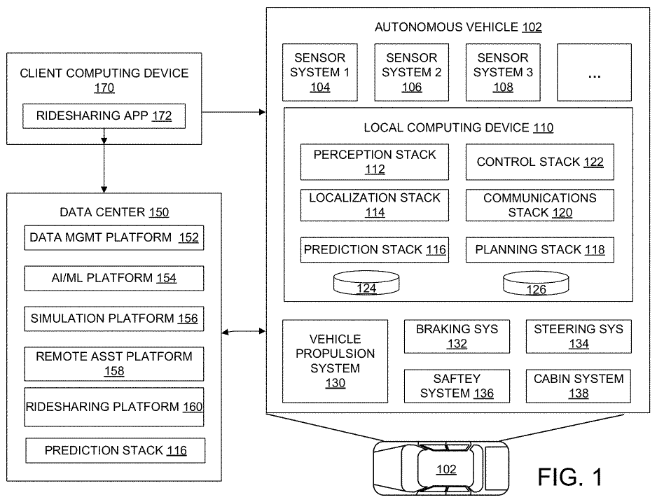

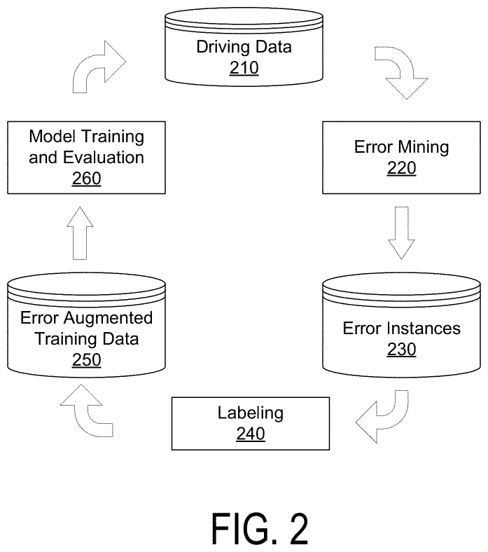

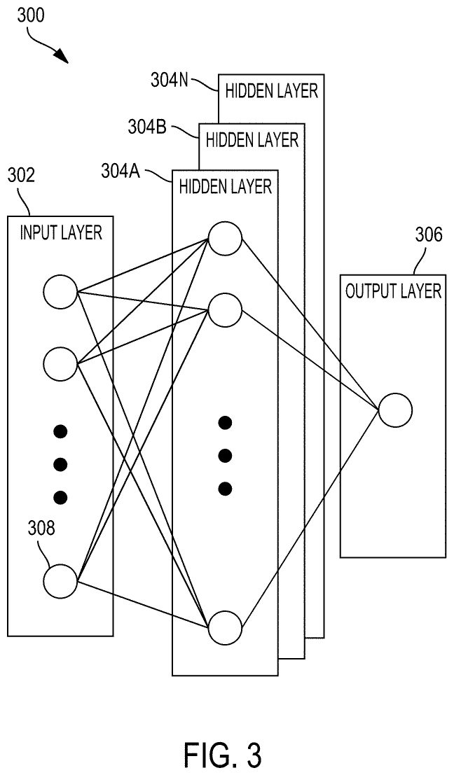

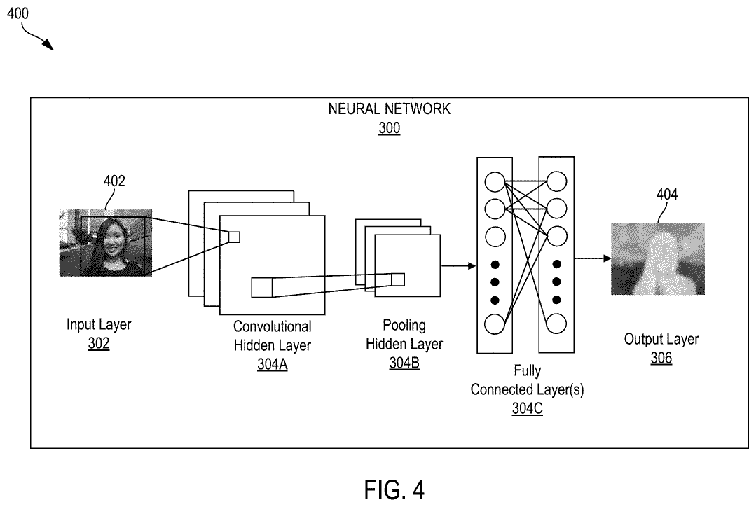

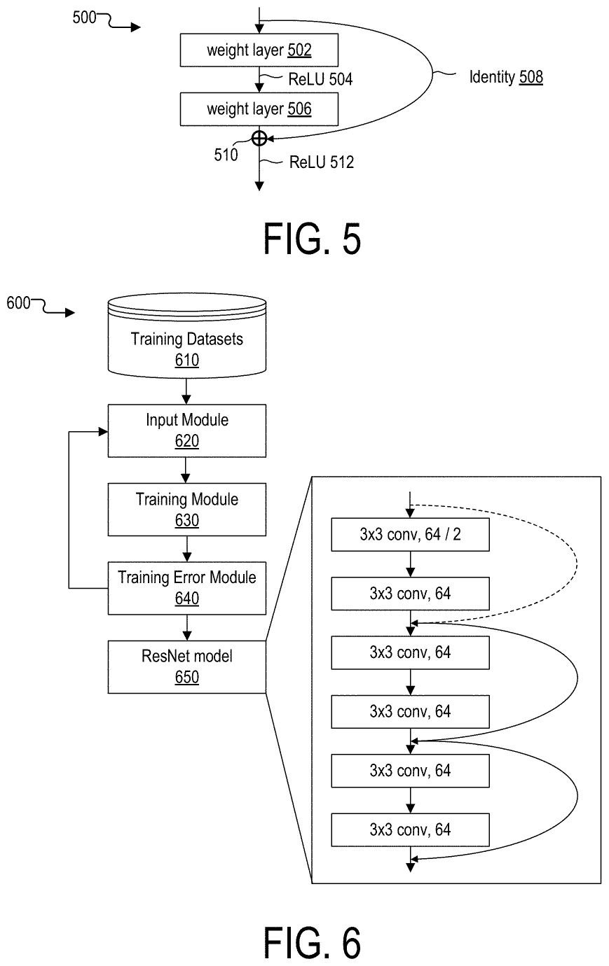

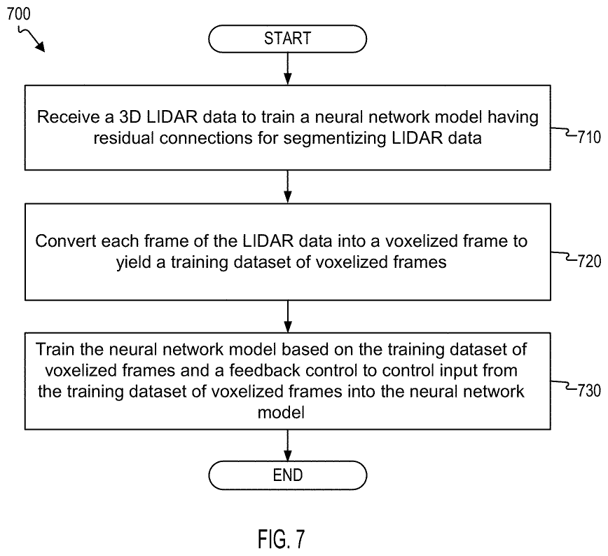

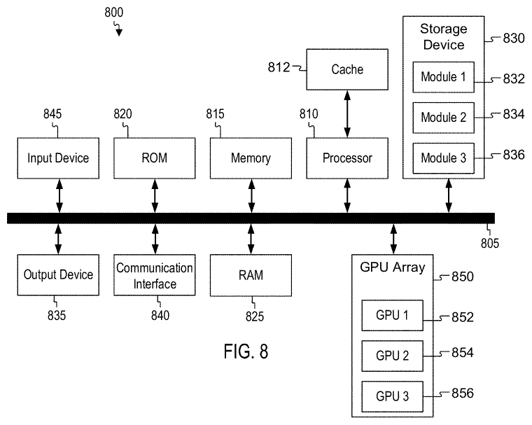

A description of an autonomous vehicle (AV) management system and a continual learning machine (CLM) for the AV management system, as illustrated in FIGS. 1 and 2, are first disclosed herein. An overview of a neural network and a training system for a neural network is disclosed in FIGS. 3 and 4. A discussion of a ResNet model and a training system for the ResNet model is disclosed in FIGS. 5 and 6. A method to train a ResNet model is then discussed in FIG. 7. The discussion then concludes with a brief description of example devices, as illustrated in FIG. 8. These variations shall be described herein as the various embodiments are set forth. The disclosure now turns to FIG. 1.

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, global positioning system (GPS) receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and a high definition (HD) geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the cartography platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the cartography platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the cartography platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

FIG. 2 illustrates an example diagram of a Continuous Learning Machine (CLM) 200 that solves long-tail prediction problem in an AV in accordance with some examples. The CLM 200 is a continual loop that iterates and improves based on continual feedback to learn and resolve driving situations experienced by the AV.

The CLM 200 begins with a fleet of AVs that are outfitted with sensors to record a real-world driving scene. In some cases, the fleet of AVs is situated in a suitable environment that represents challenging and diverse situations such as an urban environment to provide more learning opportunities. The AVs record the driving situations into a collection of driving data 210.

The CLM 200 includes an error mining 220 to mine for errors and uses active learning to automatically identify error cases and scenarios having a significant difference between prediction and reality, which are added to a dataset of error instances 230. The error instances are long-tail scenarios that are uncommon and provide rich examples for simulation and training. The error instances 230 store high-value data and prevent storing datasets with situations that are easily resolved.

The CLM 200 also implements a labeling function 240 that includes both automated and manual data annotation of data that is stored in error augmented training data 250 and used for future prediction. The automated data annotation is performed by an ML labeling annotator that uses a neural network trained to identify and label error scenarios in the datasets. Using the ML labeling annotator enables significant scale, cost, and speed improvements that allow the CLM 200 to cover mores scenario of the long tail. The labeling function 240 also includes functionality to allow a human annotator to supplement the ML labeling function. By having both an automated ML labeling function and a manual (human) labeling annotator, the CLM 200 can be populated with dense and accurate datasets for prediction.

The final step of the CLM 200 is model training and evaluation 260. A new model (e.g., a neural network) is trained based on the error augmented training data 250 and the new model is tested extensively using various techniques to ensure that the new model exceeds the performance of the previous model and generalizes well to the nearly infinite variety of scenarios found in the various datasets. The model can also be simulated in a virtual environment and analyzed for performance. Once the new model has been accurately tested, the new model can be deployed in an AV to record driving data 210. The CLM 200 is a continual feedback loop that provides continued growth and learning to provide accurate models for an AV to implement.

In practice, the CLM can handle many uncommon scenarios, but the AV will occasionally need to account for new and infrequency scenarios that would be obvious to a human. For example, an AV may encounter another motorist making an abrupt and sometimes illegal U-turn. The U-turn can be at a busy intersection or could be mid-block, but the U-turn will be a sparse data point as compared to more common behaviors such as moving straight, left turns, right turns, and lane changes. Applying our CLM principles, an initial deployment model may not optimally predict U-turn situations and error situations commonly include U-turns. As the dataset grows and more error scenarios of U-turns are identified, the model can be trained to sufficiently predict a U-turn and allow the AV to accurately navigate this scenario.

The CLM 200 can be applied to any number of scenarios that a human will intuitively recognize including, for example, a K-turn (or a 3-point turn), lane obstructions, construction, pedestrians, animated objects, animals, emergency vehicles, funeral processions, jaywalking, and so forth. The CLM 200 provides a mechanism for continued learning to account for diverse scenarios that are present in the physical world.

FIG. 3 illustrates an example of a configuration of the neural network 300. In some cases, the neural network can be used by an image processing engine in a computer system to detect features in an image, such as semantic features. In other cases, the neural network can be implemented by the image processing engine to perform other image processing tasks, such as segmentation and recognition tasks. For example, in some cases, the neural network can be implemented to perform face recognition, background-foreground segmentation, segmentation, object detection, etc.

The neural network includes an input layer 302, which includes input data. In one illustrative example, the input data at input layer 302 can include image data (e.g., an input image 402).

The neural network 300 further includes multiple hidden layers 304A, 304B, through 304N (collectively “304” hereinafter). The neural network 300 can include “N” number of hidden layers (304), where “N” is an integer greater or equal to one. The number of hidden layers can include as many layers as needed for the given application.

The neural network 300 further includes an output layer 306 that provides an output resulting from the processing performed by the hidden layers 304. In one illustrative example, the output layer 306 can provide a feature extraction or detection result based on an input image. The extracted or detected features can include, for example, and without limitation, color, texture, semantic features, etc.

The neural network 300 is a multi-layer neural network of interconnected nodes. Each node can represent a piece of information. Information associated with the nodes is shared among the different layers (302, 304, 306) and each layer retains information as it is processed. In some examples, the neural network 300 can be a feed-forward network, in which case there are no feedback connections where outputs of the network are fed back into itself. In other examples cases, the neural network 300 can be a recurrent neural network, which can have loops that allow information to be carried across nodes while reading in the input.

Information can be exchanged between nodes in the layers (302, 304, 306) through node-to-node interconnections between the layers (302, 304, 306). Nodes of the input layer 302 can activate a set of nodes in the first hidden layer 304A. For example, as shown, each of the input nodes of the input layer 302 is connected to each of the nodes of the first hidden layer 304A. The nodes of the hidden layers 304 can transform the information of each input node by applying activation functions to the information. The information derived from the transformation can then be passed to and activate the nodes of the next hidden layer 304B, which can perform their own designated functions. Example functions include, without limitation, convolutional, up-sampling, data transformation, and/or any other suitable functions. The output of the hidden layer 304B can then activate nodes of the next hidden layer, and so on. The output of the last hidden layer 304N can activate one or more nodes of the output layer 306, which can then provide an output. In some cases, while nodes (e.g., 308) in the neural network 300 are shown as having multiple output lines, a node has a single output and all lines shown as being output from a node represent the same output value.

In some cases, each node or interconnection between nodes can have a weight that is a set of parameters derived from a training of the neural network 300. For example, an interconnection between nodes can represent a piece of information learned about the interconnected nodes. The interconnection can have a numeric weight that can be tuned (e.g., based on a training dataset), allowing the neural network 300 to be adaptive to inputs and able to learn as more and more data is processed.

The neural network 300 can be pre-trained to process the features from the data in the input layer 302 using the different hidden layers 304 in order to provide the output through the output layer 306. In an example in which the neural network 300 is used to detect features in an image, the neural network 300 can be trained using training data that includes image data.

The neural network 300 can be further trained as more input data, such as image data, is received. In some cases, the neural network 300 can be trained using supervised learning and/or reinforcement training. As the neural network 300 is trained, the neural network 300 can adjust the weights and/or biases of the nodes to optimize its performance.

In some cases, the neural network 300 can adjust the weights of the nodes using a training process such as backpropagation. Backpropagation can include a forward pass, a loss function, a backward pass, and a weight update. The forward pass, loss function, backward pass, and parameter update are performed for one training iteration. The process can be repeated for a certain number of iterations for each set of training data (e.g., image data) until the weights of the layers 302, 304, 306 in the neural network 300 are accurately tuned.

To illustrate, in the previous example of detecting features in an image, the forward pass can include passing image data samples through the neural network 300. The weights may be initially randomized before the neural network 300 is trained. For a first training iteration for the neural network 300, the output may include values that do not give preference to any particular feature, as the weights have not yet been calibrated. With the initial weights, the neural network 300 may be unable to detect some features and thus may yield poor detection results for some features. A loss function can be used to analyze the error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) may be high for the first training image data samples since the actual values may be much different than the predicted output. The goal of training can be to minimize the amount of loss for the predicted output. The neural network 300 can perform a backward pass by determining which inputs (weights) most contributed to the loss of the neural network 300 and can adjust the weights so the loss decreases and is eventually minimized.

A derivative of the loss with respect to the weights (denoted as dL/dW, where Ware the weights at a particular layer) can be computed to determine the weights that most contributed to the loss of the neural network 300. After the derivative is computed, a weight update can be performed by updating all the weights of the filters. For example, the weights can be updated so they change in the opposite direction of the gradient. The weight update can be denoted as

$$w = {w}_{i} - η \frac{d L}{d W} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 300 can include any suitable neural network. One example includes a convolutional neural network (CNN), which includes an input layer and an output layer, with multiple hidden layers between the input and output layers. The hidden layers of a CNN include a series of convolutional, nonlinear, pooling, fully connected and normalization layers. The neural network 300 can include any other deep network, such as an autoencoder, deep belief nets (DBNs), a Recurrent Neural Networks (RNNs), among others.

FIG. 4 illustrates an example usage 400 of the neural network 300 for detecting features in an image. In this example, the neural network 300 includes an input layer 302, a convolutional hidden layer 304A, a pooling hidden layer 304B, fully connected layers 304C, and output layer 306. The neural network 300 can process an input image 402 to generate an output 404 representing features detected in the input image 402.

First, each pixel, superpixel or patch of pixels in the input image 402 is considered as a neuron that has learnable weights and biases. Each neuron receives some inputs, performs a dot product and optionally follows it with a non-linearity function. The neural network 300 can also encode certain properties into the architecture by expressing a differentiable score function from the raw image data (e.g., pixels) on one end to class scores at the other and process features from the image.

In some examples, the input layer 304A includes raw or captured image data. For example, the image data can include an array of numbers representing the pixels of an image (e.g., 402), with each number in the array including a value from 0 to 255 describing the pixel intensity at that position in the array. The image data can be passed through the convolutional hidden layer 304A, an optional non-linear activation layer, a pooling hidden layer 304B, and fully connected hidden layers 306 to get an output at the output layer 306. The output 404 can then identify features detected in the image data.

The convolutional hidden layer 304A can analyze the data of the input layer 302. Each node of the convolutional hidden layer 304A can be connected to a region of nodes (e.g., pixels) of the input data (e.g., image 402). The convolutional hidden layer 304A can be considered as one or more filters (each filter corresponding to a different activation or feature map), with each convolutional iteration of a filter being a node or neuron of the convolutional hidden layer 304A. Each connection between a node and a receptive field (region of nodes (e.g., pixels)) for that node learns a weight and, in some cases, an overall bias such that each node learns to analyze its particular local receptive field in the input image 402.

The convolutional nature of the convolutional hidden layer 304A is due to each node of the convolutional layer being applied to its corresponding receptive field. For example, a filter of the convolutional hidden layer 304A can begin in the top-left corner of the input image array and can convolve around the input data (e.g., image 402). As noted above, each convolutional iteration of the filter can be considered a node or neuron of the convolutional hidden layer 304A. At each convolutional iteration, the values of the filter are multiplied with a corresponding number of the original pixel values of the image. The multiplications from each convolutional iteration can be summed together to obtain a total sum for that iteration or node. The process is next continued at a next location in the input data (e.g., image 402) according to the receptive field of a next node in the convolutional hidden layer 304A. Processing the filter at each unique location of the input volume produces a number representing the filter results for that location, resulting in a total sum value being determined for each node of the convolutional hidden layer 304A.

The mapping from the input layer 302 to the convolutional hidden layer 304A can be referred to as an activation map (or feature map). The activation map includes a value for each node representing the filter results at each location of the input volume. The activation map can include an array that includes the various total sum values resulting from each iteration of the filter on the input volume. The convolutional hidden layer 304A can include several activation maps representing multiple feature spaces in the data (e.g., image 402).

In some examples, a non-linear hidden layer can be applied after the convolutional hidden layer 304A. The non-linear layer can be used to introduce non-linearity to a system that has been computing linear operations.

The pooling hidden layer 304B can be applied after the convolutional hidden layer 304A (and after the non-linear hidden layer when used). The pooling hidden layer 304B is used to simplify the information in the output from the convolutional hidden layer 304A. For example, the pooling hidden layer 304B can take each activation map output from the convolutional hidden layer 304A and generate a condensed activation map (or feature map) using a pooling function. Max-pooling is one example of a function performed by a pooling hidden layer. Other forms of pooling functions can be used by the pooling hidden layer 304B, such as average pooling or other suitable pooling functions.

A pooling function (e.g., a max-pooling filter) is applied to each activation map included in the convolutional hidden layer 304A. In the example shown in FIG. 4, three pooling filters are used for three activation maps in the convolutional hidden layer 304A. The pooling function (e.g., max-pooling) can reduce, aggregate, or concatenate outputs or feature representations in the input (e.g., image 402). Max-pooling (as well as other pooling methods) offer the benefit that there are fewer pooled features, thus reducing the number of parameters needed in later layers.

The fully connected layer 304C can connect every node from the pooling hidden layer 304B to every output node in the output layer 306. The fully connected layer 304C can obtain the output of the previous pooling layer 304B (which can represent the activation maps of high-level features) and determine the features or feature representations that provide the best representation of the data. For example, the fully connected layer 304C layer can determine the high-level features that provide the best or closest representation of the data and can include weights (nodes) for the high-level features. A product can be computed between the weights of the fully connected layer 304C and the pooling hidden layer 304B.

The output 404 from the output layer 306 can include an indication of features detected or extracted from the input image 402. In some examples, the output from the output layer 306 can include patches of output that are then tiled or combined to produce a final rendering or output (e.g., 404). Other example outputs can also be provided. Moreover, in some examples, the features in the input image can be derived using the response from different levels of convolution layers from any object recognition, detection, or semantic segmentation convolution neural network.

While the example above describes a use of the neural network 300 to extract image features, it should be noted that this is just an illustrative example provided for explanation purposes and, in other examples, the neural network 300 can also be used for other tasks. For example, in some implementations, the neural network 300 can be used to refine a disparity map (e.g., 310, 410) derived from one or more sensors. To illustrate, in some implementations, the left and right sub-pixels in the sensor can be used to compute the disparity information in the input image. When the distance between the left and right sub-pixels are too close, the disparity information can become limited when the object is distant. Therefore, a neural network can be used to optimize the disparity information and/or refine the disparity map using sub-pixels.

Training a neural network is a time-consuming and expensive process that is typically handled by a distributed system that uses multiple processing cores to compute the weights of the hidden layers. The VGG neural network produces accurate results and improves a conventional neural network such as AlexNet by replacing large kernel-sized filters with multiple 3×3 kernel-sized filters in a sequence. The VGG backbone improved the large kernel-sized filters because multiple stacked smaller size kernel is better than the one with a larger size kernel because multiple non-linear layers increase the depth of the network which enables it to learn more complex features, and that too at a lower cost. While VGG neural network is highly accurate, training a VGG neural network is expensive because of large computational requirements, both in terms of memory and time, and training is inefficient due to the large width of convolutional layers. Table 1 below illustrates a structural detail of a 16-layer VGG (VGG16) neural network and illustrates the total number of hidden parameters to tune during training exceeds 138 million parameters.

TABLE 1
VGG16

| # | Input Image | | | output | | | Layer | Stride | Kernel | | in | out | Param |
|---|---|---|---|---|---|---|---|---|---|---|---|---|---|
| 1 | 224 | 224 | 3 | 224 | 224 | 64 | conv3-64 | 1 | 3 | 3 | 3 | 64 | 1792 |
| 2 | 224 | 224 | 64 | 224 | 224 | 64 | conv3-64 | 1 | 3 | 3 | 64 | 64 | 36928 |
| | 224 | 224 | 64 | 112 | 112 | 64 | maxpool | 2 | 2 | 2 | 64 | 64 | 0 |
| 3 | 112 | 112 | 64 | 112 | 112 | 128 | conv3-128 | 1 | 3 | 3 | 64 | 128 | 73856 |
| 4 | 112 | 112 | 128 | 112 | 112 | 128 | conv3-128 | 1 | 3 | 3 | 128 | 128 | 147584 |
| | 112 | 112 | 128 | 56 | 56 | 128 | maxpool | 2 | 7 | 2 | 128 | 128 | 65664 |
| 5 | 56 | 56 | 128 | 56 | 56 | 256 | conv3-256 | 1 | 3 | 3 | 128 | 256 | 295168 |
| 6 | 56 | 56 | 256 | 56 | 56 | 256 | conv3-256 | 1 | 3 | 3 | 256 | 256 | 590080 |
| 7 | 56 | 56 | 256 | 56 | 56 | 256 | conv3-256 | 1 | 3 | 3 | 256 | 256 | 590080 |
| | 56 | 56 | 256 | 28 | 28 | 256 | maxpool | 2 | 2 | 2 | 256 | 256 | 0 |
| 8 | 28 | 28 | 256 | 28 | 28 | 512 | conv3-512 | 1 | 3 | 3 | 256 | 512 | 1180160 |
| 9 | 28 | 28 | 512 | 28 | 28 | 512 | conv3-512 | 1 | 3 | 3 | 512 | 512 | 2359808 |
| 10 | 28 | 28 | 512 | 28 | 28 | 512 | conv3-512 | 1 | 3 | 3 | 512 | 512 | 2359808 |
| | 28 | 28 | 512 | 14 | 14 | 512 | maxpool | 2 | 2 | 2 | 512 | 512 | 0 |
| 11 | 14 | 14 | 512 | 14 | 14 | 512 | conv3-512 | 1 | 3 | 3 | 512 | 512 | 2359808 |
| 12 | 14 | 14 | 512 | 14 | 14 | 512 | conv3-512 | 1 | 3 | 3 | 512 | 512 | 2359808 |
| 13 | 14 | 14 | 512 | 14 | 14 | 512 | conv3-512 | 1 | 3 | 3 | 512 | 512 | 2359808 |
| | 14 | 14 | 512 | 7 | 7 | 512 | maxpool | 2 | 2 | 2 | 512 | 512 | 0 |
| 14 | 1 | 1 | 25088 | 1 | 1 | 4096 | fc | | 1 | 1 | 25088 | 4096 | 102764544 |
| 15 | 1 | 1 | 4096 | 1 | 1 | 4096 | fc | | 1 | 1 | 4096 | 4096 | 16781312 |
| 16 | 1 | 1 | 4096 | 1 | 1 | 1000 | fc | | 1 | 1 | 4096 | 1000 | 4097000 |
| | | | | | | | Total | | | | | | 138,423,208 |

VGG16 has a total of 138 million parameters and all the convolution kernels are of size 3×3 and max pool kernels are of size 2×2 with a stride of two. Training a VGG16 network is a very slow and expensive process, in terms of computation complexity, time, and cost.

Adding additional layers to achieve better performance also does not scale linearly. That is, increasing network depth (i.e., the number of layers) does not work by simply stacking layers together. Deep networks are hard to train because of the vanishing gradient problem, which requires that a calculated gradient be backpropagated to earlier layers, and repeated multiplication may make the gradient infinitely small. As a result, as the network goes deeper, its performance gets saturated or even starts degrading.

FIG. 5 illustrates an example of a residual learning building block 500 that can reduce backpropagation to stack additional layers in accordance with some examples.

In particular, FIG. 5 illustrates that the residual learning building block 500 receives an input variable x that is applied with a weight layer 502, and then an activation function such as a reactivation linear unit (ReLU) 504 is applied to the weighted input and is then applied with a weight layer 506. The input value is denoted as F(x) based on the function applied by the weight layer 502, ReLU 504, and weight layer 506. A feedforward connection applies an identity function 508 that is summed with F(x) at an addition function 510, which yields an output of F(x)+x. The output function is then applied with an activation function such as a ReLU 512. The output of the residual learning building block 500 can be represented by Equation (1) below:

y=F(x,{wᵢ})+wₛx (Equation 1)

with wᵢ corresponding to the weight layer 502 and wₛ corresponding to the weight layer 506.

FIG. 6 illustrates an example of an illustration of training a ResNet training system 600 in accordance with some examples.

The ResNet training system 600 includes a training dataset 610 that can include conventional datasets and datasets extracted from long-tail scenarios such as the error augmented training data 250. Data diversity is necessary to accurately train the model to normal scenarios and long-tail scenarios. While long-tail scenarios are infrequent, occurrences of infrequent scenarios will occur based on usage over time and the model will need to be able to address this situation. The training dataset 610 can be three-dimensional (3D) LIDAR data represented by a 3D point cloud.

The various datasets 610 are input into an input module 620 to preprocess the input to voxelize the frames based on a current voxelization process. In one example, the input module 620 includes a max pool layer to downsample the input data based on a stride size to have an identical size during a training iteration. The input module 620 downsamples the voxelized data and inputs the downsampled data into a training module 630, which performs a training iteration to determine the weights associated with the layers of the ResNet. Conventional training consists of resizing before beginning the training iteration, which can require numerous datasets of different sizes. During training in the training module 630, the weights are batch normalized, which consists of normalizing activation vectors from hidden layers using the first and the second statistical moments (mean and variance) of the current batch. This normalization step is applied right before (or right after) the nonlinear function. In conventional distributed normalization, synchronized batch normalization is preferred to normalize the means and variances across each node to improve convergence, which reduces training time. Synchronized batch normalization is omitted in this example because the reduced layers of ResNet encourage faster convergence while synchronization adds network traffic and overhead that was found to be unnecessary.

After each iteration, a training error module 640 compares the results of the training data set to a comparison data set to identify a training error of the current training iteration of the ResNet. The training error module 640 outputs a feedback control (e.g., a confidence level, a training error rate, etc.) to the input module 620. Based on the feedback control, the input module 620 determines a resolution for datasets during the next iteration of the training.

The neural network training performs hundreds or thousands of iterations and continues until the training error module 640 determines that the training error is less than a minimum acceptable performance and the training error module 640 finalizes the weights and outputs a trained ResNet model 650, a portion of which is illustrated in FIG. 6. As illustrated in FIG. 6, the ResNet model 650 is implemented similar to a VGG network that passes an image or voxel through a stack of convolutional layers and the filters are used with a very small receptive field of 3×3, which is the smallest size to capture the notion of directionality (e.g., left/right, up/down, center). A VGG network implementation often use utilizes a 1×1 convolution filter, which can be seen as a linear transformation of the input channels (followed by non-linearity). As noted in Table 1 above, the VGG network implements three fully connected (FC) layers that follow a stack of convolutional layers and the FC layers have a different depth in different architectures. The first two FC layers have 4096 channels each, the third performs 1000-way ImageNet Large Scale Visual Recognition Challenge (ILSVRC) classification and contains 1000 channels (one for each class). The final layer is the soft-max layer.

The ResNet model 650 evolves VGG network configuration by implementing convolutional layers by implementing a plain network, most of which are 3×3 filters, that follow two design rules. First, for the same output feature map size, the layers have the same number of filters. Second, if the feature map size is halved, the number of filters is doubled to preserve the time complexity per-layer. Further, the ResNet model 650 adds the shortcut connections, further illustrated in FIG. 5 above, to skip layers and reduce backpropagation. The shortcut connections can be directly used when the input and output are of the same dimensions, which are illustrated as solid line shortcuts in FIG. 5. When the dimensions increase, there are two options. First, the shortcut connection can still perform identity mapping, with extra zero entries padded for increasing dimensions. This option introduces no extra parameter. Second, the projection shortcut in Equation 1 above is used to match dimensions by 1×1 convolutions.

The example portion of the ResNet model 650 illustrates 6 layers of the model. ResNet conventionally uses additional layers (e.g., ResNet-50, ResNet-100) to increase the accuracy over, for example, VGG networks by reducing the effects of backward propagation of the calculated weights. ResNet also improves training over VGG networks by reducing the number of parameters. For example, a 16 layer VGG network has 138 million parameters, as illustrated above in Table 1, and an 18 layer ResNet, illustrated in Table 2 below, has 11.5 million parameters.

TABLE 2
ResNet18

| # | Input Image | | | output | | | Layer | Stride | Pad | Kernel | | in | out | Param |
|---|---|---|---|---|---|---|---|---|---|---|---|---|---|---|
| 1 | 227 | 227 | 3 | 112 | 112 | 64 | conv1 | 2 | 1 | 7 | 7 | 3 | 64 | 9472 |
| | 112 | 112 | 64 | 56 | 56 | 64 | maxpool | 2 | 0.5 | 3 | 3 | 64 | 64 | 0 |
| 2 | 56 | 56 | 64 | 56 | 56 | 64 | conv2-1 | 1 | 1 | 3 | 3 | 64 | 64 | 36928 |
| 3 | 56 | 56 | 64 | 56 | 56 | 64 | conv2-2 | 1 | 1 | 3 | 3 | 64 | 64 | 36928 |
| 4 | 56 | 56 | 64 | 56 | 56 | 64 | conv2-3 | 1 | 1 | 3 | 3 | 64 | 64 | 36928 |
| 5 | 56 | 56 | 64 | 56 | 56 | 64 | conv2-4 | 1 | 1 | 3 | 3 | 64 | 64 | 36928 |
| 6 | 56 | 56 | 64 | 28 | 28 | 128 | conv3-1 | 2 | 0.5 | 3 | 3 | 64 | 128 | 73856 |
| 7 | 28 | 28 | 128 | 28 | 28 | 128 | conv3-2 | 1 | 1 | 3 | 3 | 128 | 128 | 147584 |
| 8 | 28 | 28 | 128 | 28 | 28 | 128 | conv3-3 | 1 | 1 | 3 | 3 | 128 | 128 | 147584 |
| 9 | 28 | 28 | 128 | 28 | 28 | 128 | conv3-4 | 1 | 1 | 3 | 3 | 128 | 128 | 147584 |
| 10 | 28 | 28 | 128 | 14 | 14 | 256 | conv4-1 | 2 | 0.5 | 3 | 3 | 128 | 256 | 295168 |
| 11 | 14 | 14 | 256 | 14 | 14 | 256 | conv4-2 | 1 | 1 | 3 | 3 | 256 | 256 | 590080 |
| 12 | 14 | 14 | 256 | 14 | 14 | 256 | conv4-3 | 1 | 1 | 3 | 3 | 256 | 256 | 590080 |
| 13 | 14 | 14 | 256 | 14 | 14 | 256 | conv4-4 | 1 | 1 | 3 | 3 | 256 | 256 | 590080 |
| 14 | 14 | 14 | 256 | 7 | 7 | 512 | conv5-1 | 2 | 0.5 | 3 | 3 | 256 | 512 | 1180160 |
| 15 | 7 | 7 | 512 | 7 | 7 | 512 | conv5-2 | 1 | 1 | 3 | 3 | 512 | 512 | 2359808 |
| 16 | 7 | 7 | 512 | 7 | 7 | 512 | conv5-3 | 1 | 1 | 3 | 3 | 512 | 512 | 2359808 |
| 17 | 7 | 7 | 512 | 7 | 7 | 512 | conv5-4 | 1 | 1 | 3 | 3 | 512 | 512 | 2359808 |
| | 7 | 7 | 512 | 1 | 1 | 512 | avg pool | 7 | 0 | 7 | 7 | 512 | 512 | 0 |
| 18 | 1 | 1 | 512 | 1 | 1 | 1000 | fc | | | | | 512 | 1000 | 513000 |
| | | | | | | | Total | | | | | | | 11,511,784 |

In some examples, the ResNet can sacrifice accuracy for training speed. In one implementation, a ResNet-23 model was trained that omitted synchronized batch normalization. Synchronized batch normalization increases the amount of network traffic in the distributed system to normalize the weights at each node of the distributed system. When the number of layers from the conventional approach of increases layers, batch normalization within the node was implemented and training errors converged at a faster rate as compared to synchronized batch normalization. It was discovered that the object detection performance of a ResNet-23 performance can equal to or better than VGG-19, but the ResNet-23 increases the training speed based on the backpropagation, the batch normalization, and the dynamic sizing of the input frames.

In some examples, the ResNet-23 model can be implemented in a perception stack (e.g., perception stack 112) to detect objects in a 3D scene in real time. Based on the object detection and additional sensors, the AV can identify objects to navigate the physical world. The perception stack 112 is a critical component of the AV and improving training time of a neural network improves increases the speed at which feedback can be integrated in the CLM 200. The perception stack 112 is also critically important to allow the AV to navigate the scene without contacting people, objects, animals, and other potential obstacles.

FIG. 7 illustrates an example method 700 for training the neural network model based on the training dataset of frames according to an example of the instant disclosure. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence.

According to some examples, the method includes receiving a 3D LIDAR data to train a neural network model having residual connections for detecting objects in LIDAR data at block 710. For example, the computing system 800 illustrated in FIG. 8 may receive a 3D LIDAR data to train a neural network model having residual connections for detecting objects in LIDAR data.

According to some examples, the method includes converting each frame of the LIDAR data into a voxelized frame to yield a training dataset of voxelized frames at block 720. For example, the computing system 800 illustrated in FIG. 8 may convert each frame of the LIDAR data into a voxelized frame to yield a training dataset of voxelized frames.

According to some examples, the method includes training the neural network model based on the training dataset of voxelized frames and a feedback control to control input from the training dataset of voxelized frames into the neural network model at block 730. For example, the computing system 800 illustrated in FIG. 8 may train the neural network model based on the training dataset of voxelized frames and a feedback control to control input from the training dataset of voxelized frames into the neural network model. In some examples, the training of the neural network model is performed by a distributed system that includes many computing systems that are networked together to perform the computations in parallel.

The training of the neural network model at block 730, either by a distributed system or a single computing system, may further comprise determining a dynamic resolution to train the neural network model based on a current confidence in the neural network model, controlling a max pool layer based on a stride size to resize the voxelized frame based on the dynamic resolution, and input the resized voxelized frame into the neural network model.

FIG. 8 shows an example of computing system 800, which can be for example any computing device for training or executing a neural network, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 800 includes at least one processing unit (CPU or processor) 810 and connection 805 that couples various system components including system memory 815, such as read-only memory (ROM) 820 and random access memory (RAM) 825 to processor 810. Computing system 800 can include a cache of high-speed memory 812 connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. There is no restriction on operating on any particular hardware arrangement, and therefore the basic features here may easily be substituted for improved hardware or firmware arrangements as they are developed.

Storage device 830 can be a non-volatile memory device and can be a hard disk or other types of computer readable media which can store data that are accessible by a computer, such as magnetic cassettes, flash memory cards, solid state memory devices, digital versatile disks, cartridges, RAMs, ROM, and/or some combination of these devices.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

The computing system 800 can also include a graphical processing unit (GPU) array 850 or any similar processor for performing massively complex and parallel mathematical operations such as simulations, games, neural network training, and so forth. The GPU array 850 includes at least one GPU and is illustrated to have three GPUs comprising GPU 852, GPU 854, and GPU 856. However, the GPU array 850 can be any number of GPUs. In some examples, the GPU core can be integrated into a die of the processor 810.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative Examples of the Disclosure Include:

Aspect 1. A method of training a neural network model in an autonomous vehicle (AV) for detecting objects, comprising: receiving a 3D light and detection ranging (LIDAR) data to train a neural network model having residual connections for detecting objects in LIDAR data; converting each frame of the LIDAR data into a voxelized frame to yield a training dataset of voxelized frames; and training the neural network model based on the training dataset of voxelized frames and a feedback control to control input from the training dataset of voxelized frames into the neural network model.

Aspect 2. The method of Aspect 1, wherein the neural network model comprises a 23-layer residual neural network model and the residual connection skips at least one layer of the 23-layer residual neural network model.

Aspect 3. The method of any of Aspects 1 to 2, wherein the neural network model is implemented in a perception stack in an autonomous vehicle for detecting objects proximate to the autonomous vehicle.

Aspect 4. The method of any of Aspects 1 to 3, wherein the perception stack in the autonomous vehicle performs real-time object detection in 3D LIDAR data based on the neural network model, wherein the 3D LIDAR data is provided from a 3D LIDAR detector fixed to the autonomous vehicle.

Aspect 5. The method of any of Aspects 1 to 4, wherein a number of frames in the 3D LIDAR data is equal to a number of frames in the training dataset of voxelized frames.

Aspect 6. The method of any of Aspects 1 to 5, wherein training the neural network model based on the training dataset of voxelized frames and the feedback control to control input from the training dataset of voxelized frames into the neural network model comprises: determining a dynamic resolution to train the neural network model based on a current confidence in the neural network model; controlling a max pool layer based on a stride size to resize the voxelized frame based on the dynamic resolution; and inputting the resized voxelized frame into the neural network model.

Aspect 7. The method of any of Aspects 1 to 6, wherein the max pool layer is part of a training module executed in the distributed system that provides the resized voxelized frame into the neural network model.

Aspect 8. The method of any of Aspects 1 to 7, wherein the neural network model is trained by a distributed system without synchronized batch normalization, wherein each node is the distributed system normalizes features extracted from a frame of the training dataset of voxelized frames to reduce internal covariate shift.

Aspect 9. The method of any of Aspects 1 to 8, wherein a first voxelized frame in the training dataset has a first resolution and a second voxelized frame in the training dataset has a second resolution that is different from the first resolution.

Aspect 10: A system includes a storage (implemented in circuitry) configured to store instructions and a processor. The processor configured to execute the instructions and cause the processor to: receive a 3D light and detection ranging (LIDAR) data to train a neural network model having residual connections for detecting objects in LIDAR data; convert each frame of the LIDAR data into a voxelized frame to yield a training dataset of voxelized frames; and train the neural network model based on the training dataset of voxelized frames and a feedback control to control input from the training dataset of voxelized frames into the neural network model.

Aspect 11: The system of Aspect 10, wherein the neural network model comprises a 23-layer residual neural network model and the residual connection skips at least one layer of the 23-layer residual neural network model.

Aspect 12: The system of any of Aspects 10 to 11, wherein the neural network model is implemented in a perception stack in an autonomous vehicle for detecting objects proximate to the autonomous vehicle.

Aspect 13: The system of any of Aspects 10 to 12, wherein the perception stack in the autonomous vehicle performs real-time object detection in 3D LIDAR data based on the neural network model, wherein the 3D LIDAR data is provided from a 3D LIDAR detector fixed to the autonomous vehicle.

Aspect 14: The system of any of Aspects 10 to 13, wherein a number of frames in the 3D LIDAR data is equal to a number of frames in the training dataset of voxelized frames.

Aspect 15: The system of any of Aspects 10 to 14, wherein the processor is configured to execute the instructions and cause the processor to: determine a dynamic resolution to train the neural network model based on a current confidence in the neural network model; control a max pool layer based on a stride size to resize the voxelized frame based on the dynamic resolution; and input the resized voxelized frame into the neural network model.

Aspect 16: The system of any of Aspects 10 to 15, wherein the max pool layer is part of a training module executed in the distributed system that provides the resized voxelized frame into the neural network model.

Aspect 17: The system of any of Aspects 10 to 16, wherein the neural network model is trained by a distributed system without synchronized batch normalization, wherein each node is the distributed system normalizes features extracted from a frame of the training dataset of voxelized frames to reduce internal covariate shift.

Aspect 18: The system of any of Aspects 10 to 17, wherein a first voxelized frame in the training dataset has a first resolution and a second voxelized frame in the training dataset has a second resolution that is different from the first resolution.

Aspect 19: A computer readable medium comprising instructions using a computer system. The computer includes a memory (e.g., implemented in circuitry) and a processor (or multiple processors) coupled to the memory. The processor (or processors) is configured to execute the computer readable medium and cause the processor to: receive a 3D light and detection ranging (LIDAR) data to train a neural network model having residual connections for detecting objects in LIDAR data; convert each frame of the LIDAR data into a voxelized frame to yield a training dataset of voxelized frames; and train the neural network model based on the training dataset of voxelized frames and a feedback control to control input from the training dataset of voxelized frames into the neural network model.

Aspect 20: The computer readable medium of Aspect 19, wherein the neural network model comprises a 23-layer residual neural network model and the residual connection skips at least one layer of the 23-layer residual neural network model.

Aspect 21: The computer readable medium of any of Aspects 19 to 20, wherein the neural network model is implemented in a perception stack in an autonomous vehicle for detecting objects proximate to the autonomous vehicle.

Aspect 22: The computer readable medium of any of Aspects 19 to 21, wherein the perception stack in the autonomous vehicle performs real-time object detection in 3D LIDAR data based on the neural network model, wherein the 3D LIDAR data is provided from a 3D LIDAR detector fixed to the autonomous vehicle.

Aspect 23: The computer readable medium of any of Aspects 19 to 22, wherein a number of frames in the 3D LIDAR data is equal to a number of frames in the training dataset of voxelized frames.

Aspect 24: The computer readable medium of any of Aspects 19 to 23, wherein the processor is configured to execute the computer readable medium and cause the processor to: determine a dynamic resolution to train the neural network model based on a current confidence in the neural network model; control a max pool layer based on a stride size to resize the voxelized frame based on the dynamic resolution; and input the resized voxelized frame into the neural network model.

Aspect 25: The computer readable medium of any of Aspects 19 to 24, wherein the max pool layer is part of a training module executed in the distributed system that provides the resized voxelized frame into the neural network model.

Aspect 26: The computer readable medium of any of Aspects 19 to 25, wherein the neural network model is trained by a distributed system without synchronized batch normalization, wherein each node is the distributed system normalizes features extracted from a frame of the training dataset of voxelized frames to reduce internal covariate shift.

Aspect 27: The computer readable medium of any of Aspects 19 to 26, wherein a first voxelized frame in the training dataset has a first resolution and a second voxelized frame in the training dataset has a second resolution that is different from the first resolution.

What is claimed is:

1. A method of training a neural network model in an autonomous vehicle (AV) for detecting objects, comprising:
receiving a 3D light and detection ranging (LIDAR) data to train a neural network model having residual connections for detecting objects in LIDAR data;
converting each frame of the LIDAR data into a voxelized frame to yield a training dataset of voxelized frames; and
training the neural network model based on the training dataset of voxelized frames and a feedback control to control input from the training dataset of voxelized frames into the neural network model.

2. The method of claim 1, wherein the neural network model comprises a 23-layer residual neural network model and the residual connection skips at least one layer of the 23-layer residual neural network model.

3. The method of claim 1, wherein the neural network model is implemented in a perception stack in an autonomous vehicle for detecting objects proximate to the autonomous vehicle.

4. The method of claim 3, wherein the perception stack in the autonomous vehicle performs real-time object detection in 3D LIDAR data based on the neural network model, wherein the 3D LIDAR data is provided from a 3D LIDAR detector fixed to the autonomous vehicle.

5. The method of claim 1, wherein a number of frames in the 3D LIDAR data is equal to a number of frames in the training dataset of voxelized frames.

6. The method of claim 5, wherein training the neural network model based on the training dataset of voxelized frames and the feedback control to control input from the training dataset of voxelized frames into the neural network model comprises:
determining a dynamic resolution to train the neural network model based on a current confidence in the neural network model;
controlling a max pool layer based on a stride size to resize the voxelized frame based on the dynamic resolution; and
inputting the resized voxelized frame into the neural network model.

7. The method of claim 6, wherein the max pool layer is part of a training module executed in the distributed system that provides the resized voxelized frame into the neural network model.

8. The method of claim 7, wherein the neural network model is trained by a distributed system without synchronized batch normalization, wherein each node is the distributed system normalizes features extracted from a frame of the training dataset of voxelized frames to reduce internal covariate shift.

9. The method of claim 8, wherein a first voxelized frame in the training dataset has a first resolution and a second voxelized frame in the training dataset has a second resolution that is different from the first resolution.

10. A system comprising:
a storage configured to store instructions;
a processor configured to execute the instructions and cause the processor to:
receive a 3D light and detection ranging (LIDAR) data to train a neural network model having residual connections for detecting objects in LIDAR data;
convert each frame of the LIDAR data into a voxelized frame to yield a training dataset of voxelized frames; and
train the neural network model based on the training dataset of voxelized frames and a feedback control to control input from the training dataset of voxelized frames into the neural network model.

11. The system of claim 10, wherein the neural network model comprises a 23-layer residual neural network model and the residual connection skips at least one layer of the 23-layer residual neural network model.

12. The system of claim 10, wherein the neural network model is implemented in a perception stack in an autonomous vehicle for detecting objects proximate to the autonomous vehicle.

13. The system of claim 12, wherein the perception stack in the autonomous vehicle performs real-time object detection in 3D LIDAR data based on the neural network model, wherein the 3D LIDAR data is provided from a 3D LIDAR detector fixed to the autonomous vehicle.

14. The system of claim 10, wherein a number of frames in the 3D LIDAR data is equal to a number of frames in the training dataset of voxelized frames.

15. The system of claim 14, wherein the processor is configured to execute the instructions and cause the processor to:
determine a dynamic resolution to train the neural network model based on a current confidence in the neural network model;
control a max pool layer based on a stride size to resize the voxelized frame based on the dynamic resolution; and
input the resized voxelized frame into the neural network model.

16. The system of claim 15, wherein the max pool layer is part of a training module executed in the distributed system that provides the resized voxelized frame into the neural network model

17. The system of claim 16, wherein the neural network model is trained by a distributed system without synchronized batch normalization, wherein each node is the distributed system normalizes features extracted from a frame of the training dataset of voxelized frames to reduce internal covariate shift.

18. The system of claim 17, wherein a first voxelized frame in the training dataset has a first resolution and a second voxelized frame in the training dataset has a second resolution that is different from the first resolution.

19. A non-transitory computer readable medium comprising instructions, the instructions, when executed by a computing system, cause the computing system to:
receive a 3D light and detection ranging (LIDAR) data to train a neural network model having residual connections for detecting objects in LIDAR data;
convert each frame of the LIDAR data into a voxelized frame to yield a training dataset of voxelized frames; and
train the neural network model based on the training dataset of voxelized frames and a feedback control to control input from the training dataset of voxelized frames into the neural network model.

20. The computer readable medium of claim 19, the neural network model is implemented in a perception stack in an autonomous vehicle for detecting objects proximate to the autonomous vehicle, and wherein the perception stack in the autonomous vehicle performs real-time object detection in 3D LIDAR data based on the neural network model, wherein the 3D LIDAR data is provided from a 3D LIDAR detector fixed to the autonomous vehicle.
